(19) United States
(12) Patent Application Publication
(10) Pub. No.: US 2010/0089956 A1
(43) Pub. Date: Apr. 15, 2010

(54) Bike Rack

(76) Inventor: Garrett B. Blake, Chapel Hill, NC (US)

Correspondence Address: Garrett Blake, 30074 Village Park Dr, Chapel Hill, NC, 27517, US

(21) Appl. No.: 12/554,900

(22) Filed: Nov. 25, 2009

Related U.S. Application Data
(60) Provisional application No. 61/094,867, filed on Sep. 5, 2008.

(51) Int. Cl. B62J 11/00

(52) U.S. Cl. 224/413

(57) ABSTRACT

Bicycle carrier apparatus includes a mounting plate and an adjustable telescoping arm bearing a threaded clamping member, a metal cuff which allows the pedal and crankarm to fit within and a metal cuff lined with protective gum rubber while locked into place with a hitch pin which engages the cuff trapping the crankarm in place

### FIELD OF THE INVENTION

This invention relates to a bicycle carrier adapted for mounting on a motorcycle vehicle and, more particularly, to apparatus for retaining a bicycle in a support arrangement which may be mounted on top of a motorcycle or onto a conventional motorcycle vehicle.

### BACKGROUND OF THE INVENTION

Bicycle riding has long been a popular recreational activity. In particular, in metropolitan areas and their environs, bicycle paths are maintained for the exclusive use of recreational bicycle riders in parks, along beaches and other available open flatland. Access to areas where facilities for safe, off-road bicycle riding are provided is generally accomplished by motor vehicles which are usually equipped in one way or another with racks or carriers for transporting the bicycles. Moreover, in the past few years, so-called “mountain bikes”, motocross competition and other off-road cycling have become increasingly popular. Again, access to areas where such activities are permitted is generally by means of motor vehicles equipped to transport the bicycles.

For many years, more or less standard bicycle transport arrangements have sufficed for the purposes of transporting bicycles by means of motor vehicles. The more conventional carrier racks generally incorporated a provision for supporting the rack on the vehicle bumper, either front or rear, with an arrangement for hanging the bicycle on the carrier and tying or strapping it in place. Oftentimes the carrier rack includes means for connecting the upper end of the carrier to the vehicle to secure it in place. One common type of rack is arranged to hang the top bar of the bicycle frames of two or three bicycles from a pair of horizontal support members with the bicycles being tied together and also to the vehicle.

In more recent times, due to the rising cost of fuel, environmental issues relating to global warming and our own carbon footprint, many such motor vehicle drivers are switching to more efficient and environmentally friendly motorcycles. However, the switch to such a vehicle forces the many thousands of bicycle enthusiasts to leave their bikes behind. A current need and desire for a safe, efficient and easy way for the motorcyclist to transport their bicycle exists.

Other motorcycle bike racks that have been tried either mount the bike across the motorcycle, or in most cases and there is only one that I am aware of grabs the bike from the down tube. Given the light materials today this is very bad for the bicycle and can jeopardize the bike. Also not running the bike in a linear orientation with the motorcycle is dangerous

A preferred bicycle carrier for motorcycle vehicle is one that can safely and efficiently mount and support a bicycle onto the motorcycle without upsetting the balance, safety or vision of the rider.

### SUMMARY OF THE INVENTION

Arrangements in accordance with the present invention satisfy the design criteria of the preferred bicycle carrier described above. These arrangements incorporate a mounting or support plate attaching to an adjustable telescoping arm to hold different sizes bicycles, allowing the pedal and crankarm to fit within a metal cuff lined with protective gum rubber while locked into place with a hitch pin which engages the cuff trapping the crankarm in place. The adjustable telescoping arm is held into the desired position with a threaded clamping element. The frame for this assembly is preferably made from steel box tubing, although it could be made of any other suitable material such as aluminum, rigid plastic and the like. The tubing is welded into a four sided shape providing rigidity to the entire device.

The device consists of a steel arm with a boot at end of arm, the arm is then attached to a mating surface and fork sets into a spindle lock. Bike crank arm nests into boot.

The way in which the unit attaches to the motorcycle will vary from bike to bike via a flat plate of metal with various bolts etc. depending on the motorcycle. The arm that the pedal bike attaches to is important. This is telescoping to hold different sizes, the pedal and crankarm set down into a metal cuff lined with protective gum rubber and then a hitch pin goes across the cuff trapping the crankarm in place. Attached to the side of the cuff is another piece of metal bend and a 90 degree angle this is where the front wheel stores after being removed from the bike. On the plate where the arm is attached is a quick release for the front fork to fall into and lock down (this quick release is not mine) which is how the bike attaches to the bike.

### BRIEF DESCRIPTION OF THE DRAWING

FIG. 1 depicts the top, left perspective view of the device.

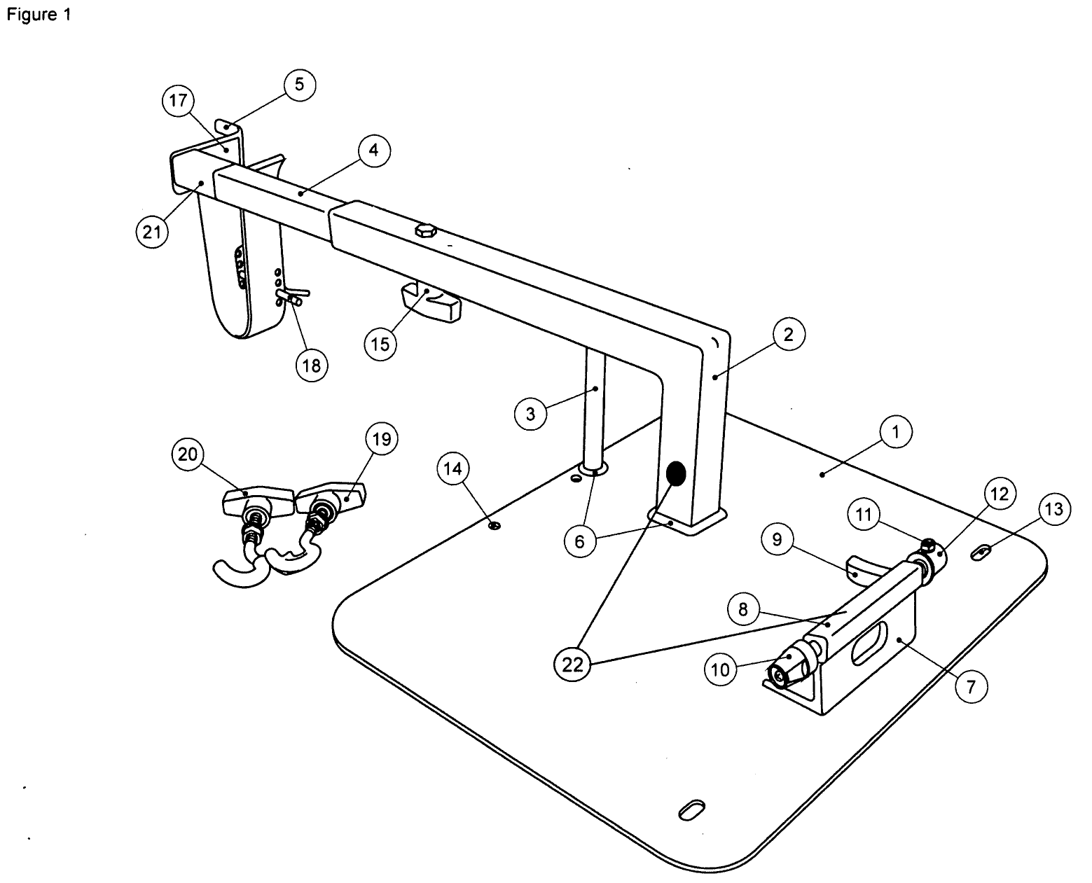

FIG. 2 depicts right side view of the device while in use.

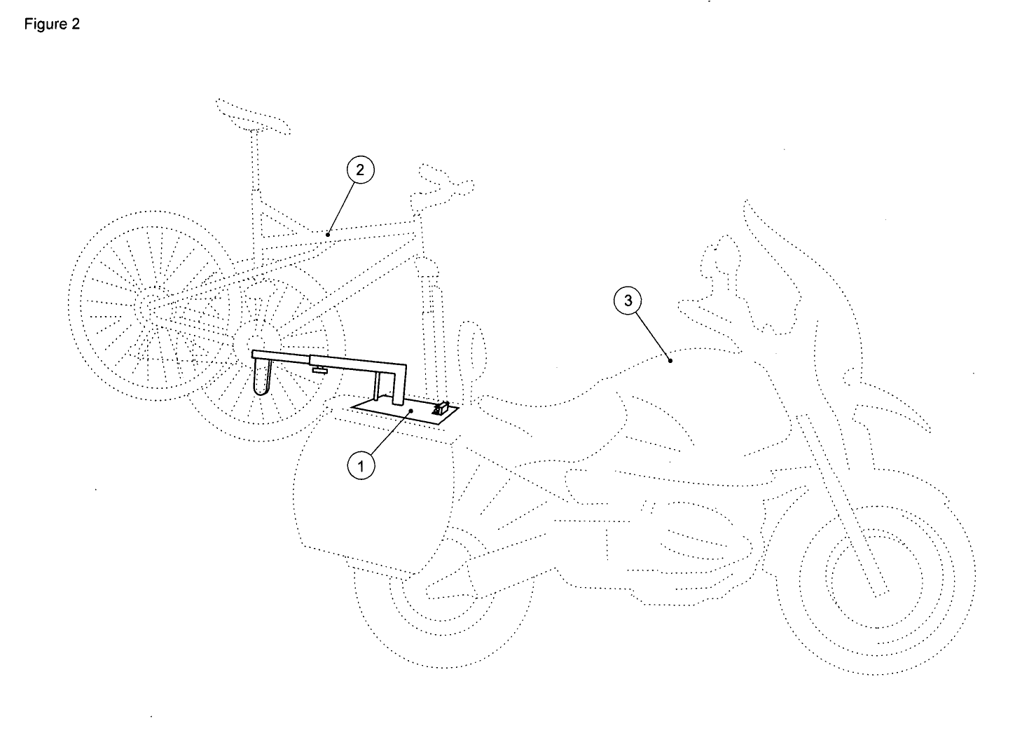

### DETAILED DESCRIPTION OF THE INVENTION

The 2×2 Bike Rack is a rack to be attached to your motorcycle for the purpose of transporting your bicycle.

Start by setting the mounting plate (1) on the rear of the motorcycle (please note the shape of item (1) can vary depending on the motorcycle. There are 4 holes (13 there are two), (14 there are two) for affixing the plate (1) to the bike. Using the provided j-hooks (20) and (19) to attach the plate (1) to the bike (note: mounting holes can vary from bike to bike)

You are now ready to lower your bicycle onto the rack. Start by removing the front wheel of the bicycle and lift the bike up and place the front forks into the fork lock (7,8) on the front of the mounting plate (22) or on the carrying arm (2) which is held in place by the welds (6). After setting the fork into the fork lock tighten (10) bolt while holding (12) and then flip the cam lock handle (9) which is attached by the nut (11) to tighten into place.

Next you want to set the bicycles left crank arm with the pedal in the down stroke position into pedal holster (17) which is the 1¾ metal sling at the end of the telescoping carrying arm (2) and (4). Make length adjustments by loosening the friction handle (15) and sliding the telescoping carrying arm (4) so it lines up with the pedal crank arm on the bike arm. After the pedal arm is nested in the pedal holster (17) and nested against the gum rubber(21) padding to protect your pedal arm you will want to slip the clevis pin (18) through the correct hole to hold the pedal down in the holster (17).

After the bike is secured you want to take the front wheel and stow it into the horizontal wheel fork (5) by sliding the axle on the front wheel into the horizontal wheel fork (5) and tighten the quick release on the wheel. You are now ready to enjoy the freedom of carrying your bike with your bike and enjoy the knowledge of lowering your carbon footprint and saving gas dollars

1. I claim a bike rack for motorcycles for the temporary transportation of bicycles comprising; an upper assembly disposed in generally a horizontal position and having a mounting plate adapted to be removably mounted onto a motorcycle, a telescoping arm member, a friction nut and bolt retaining the position of the telescoping arm extending outwardly from said mounting plate, a pedal/crank arm holster for clamping at least one bicycle onto said telescoping arm, friction tube an skewer means for securing a bicycle to said rack.

2. A bike rack according to claim 1 wherein the telescoping arm is capable of adapting to a multitude of bicycle sizes and styles.

3. A bike rack according to claim 1 wherein the mounting plate embodies a multitude of configurations to accommodate different motorcycle manufacturers.

4. A bike rack according to claim 1 wherein the pedal crank holster is adjustable for different bicycle pedal configurations.

5. A bike rack according to claim 1 wherein the forks of the bicycle temporarily mount to the fork lock on the mounting plate. Bicycle carrier apparatus includes a mounting plate and an adjustable telescoping arm bearing a threaded clamping member, a metal cuff which allows the pedal and crankarm to fit within and a metal cuff lined with protective gum rubber while locked into place with a hitch pin which engages the cuff trapping the crankarm in place
